(19) United States
(12) Patent Application Publication
(10) Pub. No.: US 2025/0363104 A1
(43) Pub. Date: Nov. 27, 2025

(54) GENERATIVE AI-BASED TENANCY CONTROL PLANE OPERATOR COACH FOR KUBERNETES CLUSTER

(71) Applicant: CIENA CORPORATION, Hanover, MD (US)

(72) Inventors: Pradeep Dubey, Haryana (IN); Sandeep Kumar, New Delhi-87 (IN); Neeraj Shrivastava, Haryana (IN)

(73) Assignee: CIENA CORPORATION, Hanover, MD (US)

(21) Appl. No.: 19/294,941

(22) Filed: Aug. 8, 2025

Related U.S. Application Data
(63) Continuation-in-part of application No. 18/643,351, filed on Apr. 23, 2024.

(30) Foreign Application Priority Data
Mar. 9, 2024 (IN) 202411017023

(51) Int. Cl. G06F 16/245; G06F 16/22; G06F 16/248

(52) U.S. Cl. CPC G06F 16/245; G06F 16/2237; G06F 16/248

(57) ABSTRACT

Aspects of the subject disclosure may include, for example, a generative AI-based Tenancy Control Plane Operator Coach that enables natural language interaction for managing multi-tenancy in containerized SaaS applications on orchestration platforms. The system uses service-defined tenancy criteria, a vector database, and a large language model to process user queries, retrieve static and live data, and provide contextually relevant responses for tenant onboarding, resource monitoring, and operational management, supporting both technical and non-technical users. Other embodiments are disclosed.

### CROSS REFERENCE TO RELATED APPLICATIONS

This application is a Continuation-In-Part of U.S. patent application Ser. No. 18/643,351, filed on Apr. 23, 2024, which claims priority to Indian Patent Application number 202411017023 filed on Mar. 9, 2024. All sections of the aforementioned applications are hereby incorporated by reference herein in their entirety.

### FIELD OF THE DISCLOSURE

The subject disclosure relates to multi-tenancy Software-as-a-Service (SaaS) applications running on container orchestration platforms.

### BACKGROUND

Kubernetes is an open-source container orchestration platform that automates the deployment, scaling, and management of containerized applications. Kubernetes has a concept of namespaces that provides a mechanism to isolate groups of resources within a single cluster. A multi-tenant SaaS application can be implemented in Kubernetes by deploying each tenant in a different namespace to isolate resources between the tenants; however, this results in deploying an instance of the entire application in each namespace. Replicating the entire application in a different namespace for each tenant may result in wasted compute resources.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a containerized SaaS application that supports multi-tenancy in a single instance of the SaaS application in accordance with various aspects described herein.

FIGS. 2A and 2B are block diagrams illustrating an example, non-limiting embodiments of services operating in a containerized SaaS application that supports multi-tenancy in a single instance of the SaaS application in accordance with various aspects described herein.

FIG. 2C is a block diagram illustrating an example, non-limiting embodiment of a sequence for tenant onboarding in a containerized SaaS application that supports multi-tenancy in a single instance of the SaaS application in accordance with various aspects described herein.

FIGS. 3A-3C depict illustrative embodiments of methods in accordance with various aspects described herein.

FIG. 4 is a block diagram of an example, non-limiting embodiment of a computing environment in accordance with various aspects described herein.

FIG. 5 is a block diagram illustrating an example, non-limiting embodiment of a system that includes a tenancy control plane operator coach that provides a natural language interface to a containerized orchestration platform in accordance with various aspects described herein.

FIG. 6 depicts illustrative embodiments of methods in accordance with various aspects described herein.

### DETAILED DESCRIPTION

The subject disclosure describes, among other things, illustrative embodiments for containerized SaaS applications that support multi-tenancy in a single instance of the containerized SaaS application. Other embodiments are described in the subject disclosure.

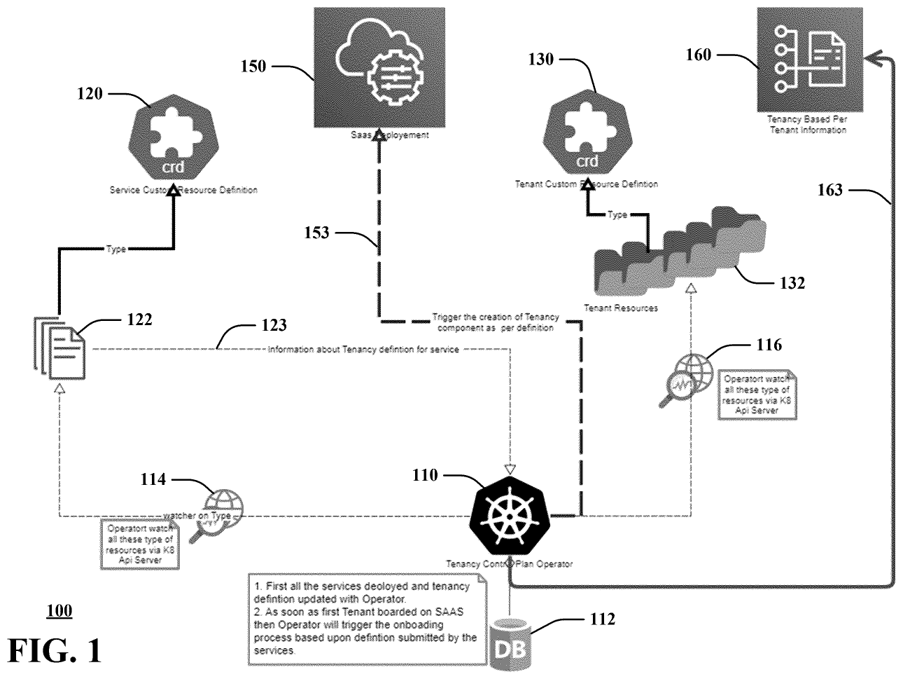

One or more aspects of the subject disclosure include a non-transitory machine-readable medium, comprising executable instructions that, when executed by a processing system including a processor, facilitate performance of operations. The operations may include receiving, at a control plane operator (e.g., 110; FIG. 1) running on a container orchestration platform, tenancy definitions for each of a plurality of services running in a containerized Software-as-a-Service (SaaS) application that supports multi-tenancy in a single instance of the containerized SaaS application; and storing the tenancy definitions for each of the plurality of services in a database accessible to the control plane operator for future creation of tenancy components for each of the plurality of services as tenants are onboarded in the containerized SaaS application.

Additional aspects of the subject disclosure include monitoring, at the control plane operator, for changes in the tenancy definitions; the receiving the tenancy definitions comprising being alerted that a custom resource definition (CRD) has been created; and the storing the tenancy definitions comprising retrieving the tenancy definitions from the CRD and storing the tenancy definitions in the database.

One or more aspects of the subject disclosure include a non-transitory machine-readable medium, comprising executable instructions that, when executed by a processing system including a processor, facilitate performance of operations. The operations may include receiving, at a control plane operator running on a container orchestration platform, an indication that a tenant is being onboarded in a containerized Software-as-a-Service (SaaS) application that supports multi-tenancy in a single instance of the containerized SaaS application; and creating tenancy components for each of a plurality of services in the containerized SaaS application to support the multi-tenancy in each of the plurality of services, wherein the tenancy components are defined by tenancy definitions provided by each of the plurality of services.

Additional aspects of the subject disclosure include the receiving the indication that the tenant is being onboarded comprising being alerted that a custom resource definition (CRD) for the tenant (Tenant CRD) has been created, and marking the Tenant CRD as complete in response to all tenancy components for each of the plurality of services having been created.

Additional aspects of the subject disclosure include the receiving the indication that the tenant is being onboarded comprising receiving a Kubernetes Watch event and/or polling a resource state using a Kubernetes application programming interface (API). Further additional aspects include the creating the tenancy components comprising instructing each of the plurality of services in the containerized SaaS application to create the tenancy components.

One or more aspects of the subject disclosure include a non-transitory machine-readable medium, comprising executable instructions that, when executed by a processing system including a processor, facilitate performance of operations. The operations may include receiving, at a control plane operator running on a container orchestration platform, a request for resource usage information related to a containerized Software-as-a-Service (SaaS) application that supports multi-tenancy in a single instance of the containerized SaaS application through tenancy definitions provided by a plurality of services in the containerized SaaS application; and providing, by the control plane operator the resource usage information.

Additional aspects of the subject disclosure include the control plane operator, the containerized SaaS application, and the plurality of services are deployed in a common Kubernetes namespace, embodiments in which the control plane operator is part of the containerized SaaS application, embodiments in which the control plane operator is part of the container orchestration platform, and embodiments in which the control plane operator is implemented as a custom resource in a Kubernetes cluster.

Further additional aspects of the subject disclosure include methods performed as a result of the operations described above, as well as devices that perform the methods.

Various embodiments described herein provide a solution to define and manage the tenancy criteria for services managed in any container orchestration platform like Kubernetes. This disclosure describes the solutions using Kubernetes as an example; however, the various embodiments may be employed in any container orchestration platform.

Services running inside a single namespace inside a Kubernetes cluster cannot currently define the criteria based on which they want to manage different tenants. Different components or services running inside the Kubernetes cluster may want to manage different tenants in different ways. For example, in the case of Cassandra (an Apache NoSQL distributed database), an application may achieve isolation by creating different key spaces for every customer. In the case of Kafka (an Apache distributed event streaming platform), tenancy isolation may be achieved by creating different partitions for different tenants. In the case of Postgres (an open-source relational database), tenancy isolation may be achieved by providing a separate database instance for every tenant. In some embodiments, one or more services may have a requirement in which they want to have separate service instance for every tenant. The foregoing service-level multi-tenancy definitions are provided as examples. In some embodiments, each service may provide its own definitions and requirements to implement multi-tenancy.

In various embodiments, a controller (referred to herein as a “Tenant Control Plane,” “Tenant Control Plane Controller,” or “Tenant Control Plane Operator”) is provided to manage the multiple tenants in a single instance of a SaaS application in a Kubernetes cluster in accordance with tenancy definitions provided by services. For example, the Tenant Control Plane may receive tenancy definitions provided by services, and then ensure that tenant isolation is provided when a tenant is onboarded by informing the services to create tenant resources that comply with the tenancy definitions. The Tenant Control Plane communicates with each service running inside a Kubernetes cluster and each service reports the criteria (e.g., tenancy definitions) based on how it wants to allocate resources when a new tenant is being added to the system. Based on the information it receives from the services, the Tenant Control Plane requests the Kubernetes cluster (through REST APIs) to allocate or provision the required resources inside the cluster.

Various embodiments described herein provide tenancy management at a more granular level than resources modeled by Kubernetes. For example, Kubernetes supports Role based Access Control (RBAC), but RBAC works only on the resources modelled by Kubernetes. This is in contrast to the embodiments described herein, in which multiple tenants may share resources (e.g., services) within a Kubernetes resource (e.g., the Pod).

Along with provisioning the required resources inside the Kubernetes cluster, in some embodiments, the Tenant Control Plane keeps all the information related to a particular tenant, and may provide an API support providing metrics for a specific tenant. For example, if an administrator wants to query the resources (e.g., CPU, Memory etc.) that a particular tenant is consuming, then the Tenant Control Plane layer provides a consolidated view through an API, and based on this information, the administrator can take further action if required. The Tenant Control Plane is capable of providing this view at a lower level than Kubernetes resources. This may also help the onboarding process of the Tenant. For example, the Tenant Control Plane has an upfront awareness of all the desired tenancy definitions for all the services and is capable of providing continuous updates during the tenant onboarding process. It may also help in debugging in case the onboarding process experiences issues. For example, if the onboarding process gets stuck, then the Tenant Control Plane may provide useful information that aids in identifying where/why the process is stuck. Also for example, the Tenant Control Plane operator may provide a share-of-pie analysis showing resource consumption on a tenant specific bases, and may also be used to aid in the billing process.

In some embodiments, the Tenant Control Plane may be implemented as a custom resource by using the Kubernetes API. In other embodiments, the Tenant Control Plane may be implemented as part of the containerized orchestration platform (e.g., part of the Kubernetes distribution).

As described herein, services define their tenancy definition as soon as they get deployed on the Kubernetes platform. Tenancy definition may vary for each service. This definition will be applied to each tenant as soon as it is boarded in the deployment. Later, if a service has changed its tenancy definition, then it will be redistributed from the center place only. This is a seamless workflow and services have more flexibility in tenancy models. Even introducing a new service or replacing an existing service with a new technology stack is also supported.

For example, a database service may have a tenancy definition which requires a separate database for each customer. If the SaaS application owner has decided to switch to a database which supports sharding, then the tenancy definition can be that each customer will have separate shards. This complete use case is easily handled by the embodiments described herein. Migration from an old service to a new service can also be tracked under this tenancy realization cycle.

One or more aspects of the subject disclosure include a non-transitory machine-readable medium, comprising executable instructions that, when executed by a processing system including a processor, facilitate performance of operations. The operations may include converting, into embeddings, static information comprising tenancy definitions from custom resource definitions, system documentation, and operational workflows associated with a plurality of services in a containerized Software-as-a-Service (SaaS) application running on a container orchestration platform, wherein the SaaS application supports multi-tenancy in a single instance; storing the embeddings in a vector database; receiving, via a natural language interface, a query related to tenancy management or resource usage of the SaaS application; retrieving, in response to the query, relevant static information from the vector database using similarity search based on the embeddings; obtaining live data from the container orchestration platform by generating and executing one or more application programming interface (API) calls based on the query and the relevant static information; processing the query, the relevant static information, and the live data using a large language model to generate a contextually relevant response in natural language; and providing the contextually relevant response to the natural language interface.

Additional aspects of the subject disclosure may include that the natural language interface comprises a chatbot interface configured to provide responses in layman's terms for non-technical users; that the natural language interface comprises a command line interface configured to provide technical responses for advanced users; that the vector database utilizes cosine similarity to match the query with relevant content; and that the operations further comprise dynamically ingesting updated tenancy definitions or documentation into the vector database at runtime in response to changes in service tenancy requirements.

Further aspects may include that obtaining the live data comprises generating Kubernetes commands to obtain live resource availability data from the container orchestration platform; that the operations further comprise updating the vector database with new or modified static information in response to changes in service tenancy definitions or operational workflows at runtime; and that the large language model is configured to generate Kubernetes commands based on the query and the retrieved static information to obtain the live data from the container orchestration platform.

Additional aspects may include that the contextually relevant response generated by the large language model includes actionable recommendations for resource scaling or tenant redistribution based on the combined static and live data; and that the operations further comprise updating the vector database with new or modified onboarding requirements in response to changes in service tenancy definitions.

One or more aspects of the subject disclosure include a non-transitory machine-readable medium, comprising executable instructions that, when executed by a processing system including a processor, facilitate performance of operations. The operations may include receiving, via a natural language interface, a query related to tenancy management of a containerized Software-as-a-Service (SaaS) application running on a container orchestration platform, wherein the SaaS application supports multi-tenancy in a single instance and comprises a plurality of services, each service providing tenancy definitions via custom resource definitions; retrieving, in response to the query, static tenancy information from a vector database, the vector database comprising embeddings of tenancy definitions, documentation, and operational workflows associated with the plurality of services; processing the query and the retrieved static tenancy information using a large language model to generate a contextually relevant response in natural language; and providing the contextually relevant response to a user via the natural language interface.

Additional aspects of the subject disclosure may include obtaining live data from the container orchestration platform by generating and executing one or more application programming interface (API) calls based on the query and the retrieved static tenancy information; and that the containerized SaaS application is deployed in a common Kubernetes namespace.

Further aspects may include that the natural language interface comprises a chatbot interface configured to provide responses in layman's terms for non-technical users; that the natural language interface comprises a command line interface configured to provide technical responses for advanced users; and that the vector database utilizes cosine similarity to match the query with relevant content.

Additional aspects may include dynamically ingesting updated tenancy definitions or documentation into the vector database at runtime in response to changes in service tenancy requirements; and that the contextually relevant response includes an assessment of the feasibility of onboarding a new tenant with a specified profile based on current resource availability and predefined tenancy criteria.

One or more aspects of the subject disclosure include a non-transitory machine-readable medium, comprising executable instructions that, when executed by a processing system including a processor, facilitate performance of operations. The operations may include receiving, via a natural language interface, a request for resource usage information related to a containerized Software-as-a-Service (SaaS) application running on a container orchestration platform, wherein the SaaS application supports multi-tenancy in a single instance; obtaining live resource usage data from the container orchestration platform by generating and executing one or more application programming interface (API) calls based on the request; processing the request and the live resource usage data using a large language model to generate a contextually relevant response in natural language; and providing the contextually relevant response to a user via the natural language interface.

Various embodiments described herein include a generative AI-based natural language interface, referred to as the TCPO Coach. The TCPO Coach is configured to receive user queries in natural language, either through a chatbot interface for non-technical users or a command line interface for advanced users. This interface allows users to interact with the TCPO and retrieve information or perform actions without requiring expertise in Kubernetes or the underlying technical details of the system.

The TCPO Coach leverages a vector database that stores embeddings of static information, including tenancy definitions, system documentation, and operational workflows. An Ingest Data module processes this static information and generates high-dimensional vector representations, or embeddings, that capture the semantic meaning of the original content. These embeddings enable efficient similarity search and retrieval of relevant information in response to user queries.

When a user submits a query, the TCPO Coach processes the query and initiates a similarity search within the vector database to identify the most relevant static information. The system utilizes similarity measures such as cosine similarity to match the query with stored embeddings, ensuring that the most contextually appropriate content is retrieved even if the query is phrased differently from the source material.

In some embodiments, the TCPO Coach is further configured to obtain live data from the container orchestration platform by generating and executing one or more API calls based on the user query and the retrieved static information. For example, if a user asks about the feasibility of onboarding a new tenant with a specific profile, the system may retrieve current resource availability and compare it with the predefined tenancy criteria to generate an informed response.

The system incorporates (or communicates with) a large language model (LLM) that processes the user query, the retrieved static information, and any obtained live data to generate a contextually relevant response in natural language. The LLM is adapted to interpret both technical and non-technical queries, generate Kubernetes commands as needed, and provide actionable recommendations, troubleshooting guidance, or technical breakdowns depending on the operational context.

The architecture supports dynamic ingestion and updating of the vector database at runtime. When new or modified tenancy definitions, documentation, or operational workflows become available, the Ingest Data module processes the updates and refreshes the embeddings in the vector database. This ensures that the system remains current and responsive to changes in service configurations or organizational policies.

The TCPO Coach is designed to support a wide range of use cases, including feasibility assessments for tenant onboarding, resource usage analysis, and operational troubleshooting. For example, a user may ask, “Can I add a 6th tenant to my Kafka cluster?” and receive a response such as, “The Kafka cluster is currently 80% utilized with 4 tenants. Adding a 6th tenant may require additional resources to avoid overloading the system.” Advanced users may request detailed technical breakdowns, such as resource allocation for a specific tenant profile, and receive comprehensive reports including quotas, isolation mechanisms, and usage trends.

The system is further configured to log each user query and the corresponding response for audit or compliance purposes. These logs may include timestamps, user identifiers, and the context of each query, supporting robust operational oversight and traceability.

In some embodiments, the TCPO, the SaaS application, and the plurality of services are deployed within a common Kubernetes namespace. This deployment model facilitates efficient resource sharing, streamlined management, and consistent application of tenancy definitions across all services.

In some embodiments, the system is capable of providing step-by-step onboarding workflows, resource usage summaries, and explanations of resource constraints or policy limitations that may impact onboarding or ongoing operations. These features enhance transparency and support informed decision-making for both technical and non-technical users.

Policy-aware filtering is supported through the integration of an NLP query contextual help and MCP filter, which ensures that responses to user queries are aligned with management and control plane policies or access control requirements. This enables the system to deliver responses that are tailored to the user's context and the operational environment of the container orchestration platform.

FIG. 1 is a block diagram illustrating an example, non-limiting embodiment of a system that includes a containerized SaaS application that supports multi-tenancy in a single instance of the SaaS application in accordance with various aspects described herein. System 100 includes containerized SaaS application 150, tenancy control plane operator 110, database 112, services 122, service custom resource definitions 120, tenant custom resource definitions 130, tenant resources 132, and reporting API 160.

As shown in FIG. 1, Tenant Control plane Operator 110 may manage multi-tenancy in a Kubernetes cluster. When an application (e.g., containerized application 150) which supports SaaS gets deployed in any Kubernetes cluster, all of the services (also referred to herein as “micro-services”) 122 create their own Custom Resource Definition (Service CRD) having the information about their tenancy definition as depicted in FIG. 1 by Service CRD 120.

Tenant Control plane Operator 110 watches for the creation of Service CRDs through the Kubernetes API server as shown at 114. As soon as a Service CRD gets created, Tenant Control Plane Operator 110 fetches at 123 the tenancy definition in the Service CRD and persists it in database 112, which is accessible to Tenant Control Plane Operator 110. In some embodiments, Tenant Control Plane Operator 110 watches for the creation of Service CRDs using Kubernetes Watch events. Also in some embodiments, Tenant Control Plane Operator 110 watches for the creation of Service CRDs by polling a resource state using a Kubernetes API.

When a tenant gets onboarded in the system, application 150 creates a new CRD instance of the tenant (Tenant CRD) 130. Tenant Control plane Operator 110 watches for the creation of Tenant CRDs through the Kubernetes API server as shown at 116. Once Tenant Control Plane Operator 110 receives the notification of the tenant onboarding, it triggers the creation of tenancy components in SaaS deployment as depicted at 153. Once all the tenancy components are created in the application for a particular tenant, the Tenancy Control Plane Operator 110 marks the Tenant CRD as complete which means that the containerized SaaS application is ready to execute any workflow for that tenant.

Tenant Control Plane Operator 110 has the information of all the resources and their allocated tenants. So, in the running SaaS application if user wants to fetch information like resources consumed by a particular tenant, then it can be retrieved at API 160 as depicted in FIG. 1 at 163.

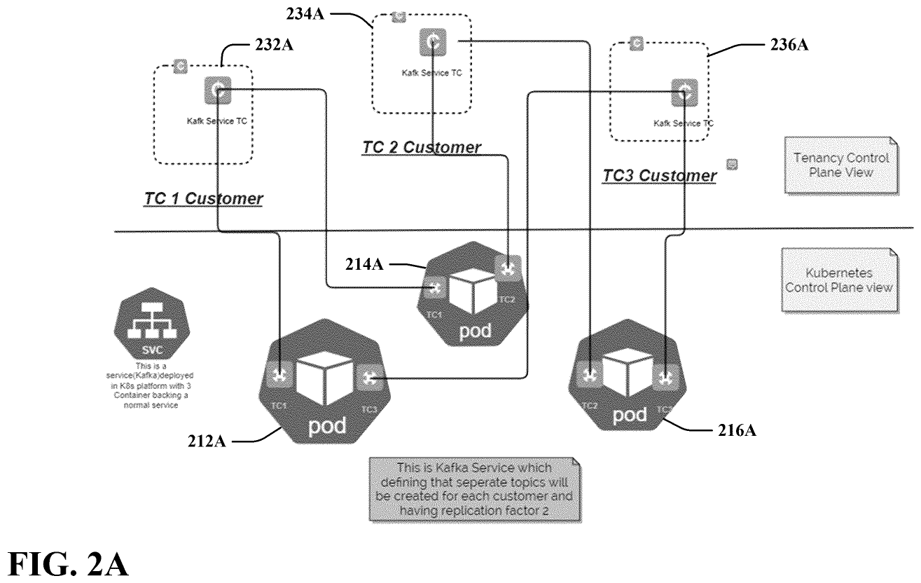

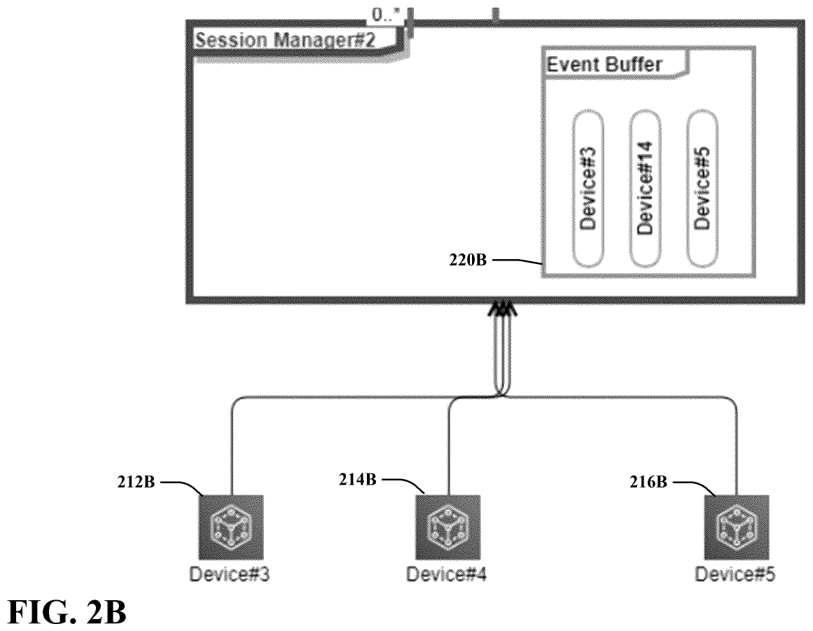

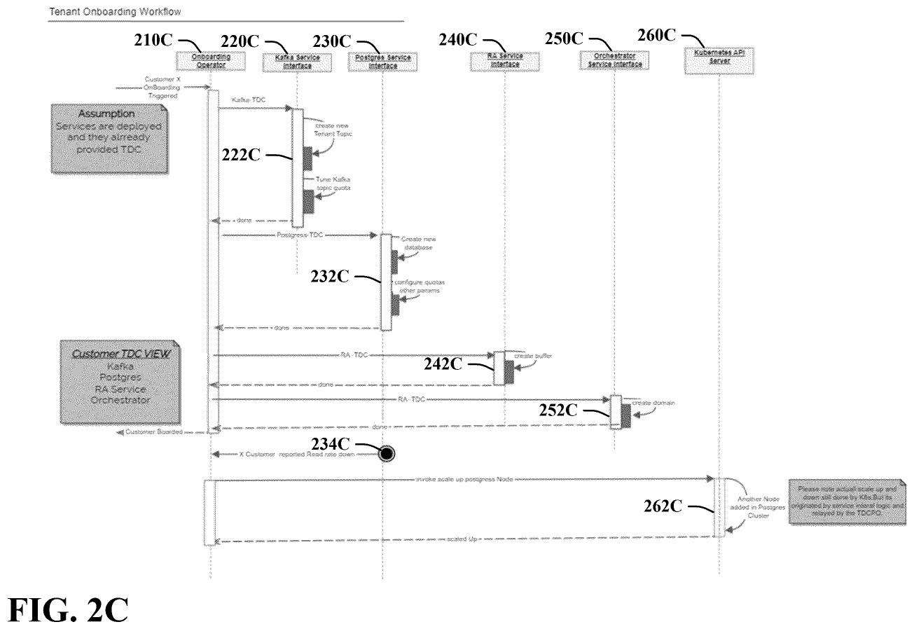

FIGS. 2A and 2B are block diagrams illustrating an example, non-limiting embodiments of services operating in a containerized SaaS application that supports multi-tenancy in a single instance of the SaaS application in accordance with various aspects described herein. The services shown in FIGS. 2A and 2B, and their manner of implementing multi-tenancy are examples. Services are free to implement multi-tenancy in any manner through the creation of Service CRDs.

FIG. 2A shows an example implementation of a multi-tenancy Kafka service. In this example, the Kafka service, when deployed, creates a Service CRD with a tenancy definition that requires a separate Kafka topic to be created for each tenant (or “customer”) such that a tenant identifier is embedded in the topic name, and defined topics have a replication factor of two. This is shown in FIG. 2A with customers 232A, 234A, and 236A, each having access to a common Kafka service in the SaaS application, but with isolation provided by the resources created according to tenancy definitions in the Service CRD created by the Kafka service. Three Kafka pods 212A, 214A, 216A, are created, in a manner that supports the replication factor of two.

Other example tenancy definitions may include a topic being limited to using not more than 20% of the available capacity of Kafka (governed by the Kafka quota provided by the service, not by the container orchestration platform). Additional tenancy definitions may include rules governing lag not being increased by a certain threshold value of X, or rules governing scaling or tenant redistribution.

In some embodiments, if backpressure reaches a certain defined limit of X or the size of the partitions is increased beyond a defined limit, then traffic for that customer can either be redistributed to other Kafka clusters or new Kafka clusters can be spawned. Also in some embodiments, if backpressure goes down, then Kafka clusters can be scaled down as well.

The Tenancy Control Plane view in FIG. 2A is showing different customers like TC 1 Customer, TC 2 Customer and TC 3 Customer, and the Kubernetes view in FIG. 2A is showing a single Kafka service cluster (cluster of 3 nodes) which is serving all three customers. Accordingly, Kubernetes sees a single application with a single Kafka service, whereas the Tenancy Control Plane Operator sees a multi-tenancy SaaS application serving multiple customers (tenants) with services that define their own multi-tenancy schemes through custom resource definitions.

FIG. 2B shows an example implementation of a multi-tenancy Resource Adapter Service. The role of this service is to listen to the data on the socket for various protocols (Like TL1, Netconf, gnmi etc.). It reads data from different customer devices and puts them in a dedicated buffer defined per customer. As per this design, there is no need to have multiple services running to hear the data from the network until there is heavy traffic coming from the network. So, traffic level permitting, the maximum number of customers may be managed by a single service instance. According to the Service CRD for the resource adapter service, the events are segregated and isolation between different customer devices is provided. In the example of FIG. 2B, the isolation of a single tenant's resources is shown. Event buffer 220 is a buffer dedicated to a single tenant that desires to listen for traffic from devices 212B, 214B, and 216B. The traffic from these devices is placed in the event buffer 220 which is dedicated to the same tenant.

In this example, the resource adapter service, when deployed, creates a Service CRD with a tenancy definition that requires a dedicated buffer to be created per customer. Thes size or bouncing limit of the buffer can be defined as per the customer profile. For example, a buffer size for a “Gold” level customer may be higher than for a “Bronze” level customer. Other example tenancy definitions may include the buffer size being kept to a particular maximum threshold size. If it goes beyond that then the appropriate algorithm may be used to drop the events. Additional tenancy definitions may include rules governing scaling or redistribution. For example, if traffic is high from the network then buffers can report that information and another instance of the service may be spawned to take care of load. The same in case a downscale is required.

Any type of service may provide tenant definitions and support multi-tenancy. For example, an Orchestrator Service may support multi-tenancy. In this example, the service takes care of all the provisioning requests coming from either the REST interface or UI. These requests may belong to multiple customers. In some embodiments, this service may use a concept of the domain per customer. In these embodiments, the service may create a logical group referred to as “domains” that provides an isolation of data for different customers. For example, domain X data should be completely isolated and should not impact domain Y in any way whether it is in terms of consuming resources or computation. As an example, in NMS systems, practically there is not much provisioning or high requests so, in spite of having separate services for each customer, single service with multiple domains can fulfill the requirement which is cost-effective and easy to manage.

In this example, the orchestrator service, when deployed, creates a Service CRD with a tenancy definition that requires separate domains to be created for each customer, where requests persisted or processed within a domain are fixed or configurable.

Other example tenancy definitions may include a number of requests that can be processed in each domain at any given point in time can be made configurable. Additional tenancy definitions may include rules governing scaling or redistribution. For example, if the number of requests from northbound increases and the configured rate is not able to support, then another instance of the orchestrator service may be launched.

In another example, a Postgres Service may support multi-tenancy. In this example, each customer may have a separate database with the same schema, where each database name includes a tenant identifier to provide isolation. Additional tenancy definitions may include rules governing scaling or redistribution. For example, the size of the per-customer database may be limited to not increase by factor X, and/or a read query per customer database may be limited to Y rate/sec in case all tenant is providing the same load, and/or the Upsert rate per customer database may be limited to Z. Any of the above may be cross-checked with the pg_stat activity table, but this is one of the ways that services are free to implement their own multi-tenancy definitions. Additional tenancy definitions may include rules governing scaling or redistribution. For example, if the customer database is not able to meet the read requirements, then it may be time to HA scale the replica node. Also for example, if the size of the database increases with the decided limit then this customer database may be shipped to a different cluster.

FIG. 2C is a block diagram illustrating an example, non-limiting embodiment of a sequence for tenant onboarding in a containerized SaaS application that supports multi-tenancy in a single instance of the SaaS application in accordance with various aspects described herein. As shown in FIG. 2C, onboarding operator 210C represents the tenant control plane operator and operations taken thereby with respect to onboarding a tenant. In the context of FIG. 2C, a tenant is onboarded in a SaaS application having four services: Kafka service 220C, Postgres service 230C, RA service 240C, and orchestrator service 250C. The number of services in FIG. 2C is purposely kept to a small number for illustration purposes. In some embodiments, the number of services that exist within a containerized multi-tenant SaaS application may be in the hundreds or even thousands.

The operations shown in FIG. 2C take place after a SaaS application has been deployed, and all of the services within the SaaS application have created their own Service CRD with tenant definitions. The tenant control plane operator has (e.g., through a watch event, or by polling) been notified of the creation of all of the Service CRDs associated with the services, and persisted that information in its own accessible database. The SaaS application has started the process of onboarding a new tenant, and has created a Tenant CRD. The tenant control plane operator has (e.g., through a watch event, or by polling) been notified that a new tenant is being onboarded. It is at this point that the operations in FIG. 2C take place to onboard the tenant in each of the services according to their own tenant definitions.

In response to an indication that a new tenant is being onboarded, the onboarding operator 210C within the tenant control plane operator, alerts the Kafka service 220C to perform operations to create tenant resources within the service to provide isolation for the tenant. For example, the onboarding operator 210C may provide a tenant identifier, such as a tenant name, to Kafka service 220C, and Kafka service 220C may create a new tenant topic and tune the Kafka topic quota at 222C using the tenant identifier. Once the Kafka service has completed the tenant onboarding it returns an indication to onboarding operator 210C that it is complete.

Similar operations are performed with all remaining services that have created Service CRDs with tenant definitions. For example, onboarding operator 210C alerts Postgres service 230C, and Postgres service 230C creates a new database and configures quotas and other parameters at 232C. Similarly, onboarding operator 210C alerts RA service 240C, which creates a buffer for the tenant at 242C. Also similarly, onboarding operator 210C alerts orchestrator service 250C, which creates a domain at 252C.

When onboarding operator 210C has completed the tenant onboarding for each of the services that created service CRDs with tenant definitions, the tenant control plane operator marks the tenant CRD as complete, thereby notifying the SaaS application that the onboarding process is complete and that workflow may begin.

Also shown in FIG. 2C is a particular customer reporting a drop in read rate in the Postgres service 230C at 234C. In response, onboarding operator 210C may make a call to Kubernetes API 260C to scale up a Postgres node at 262C.

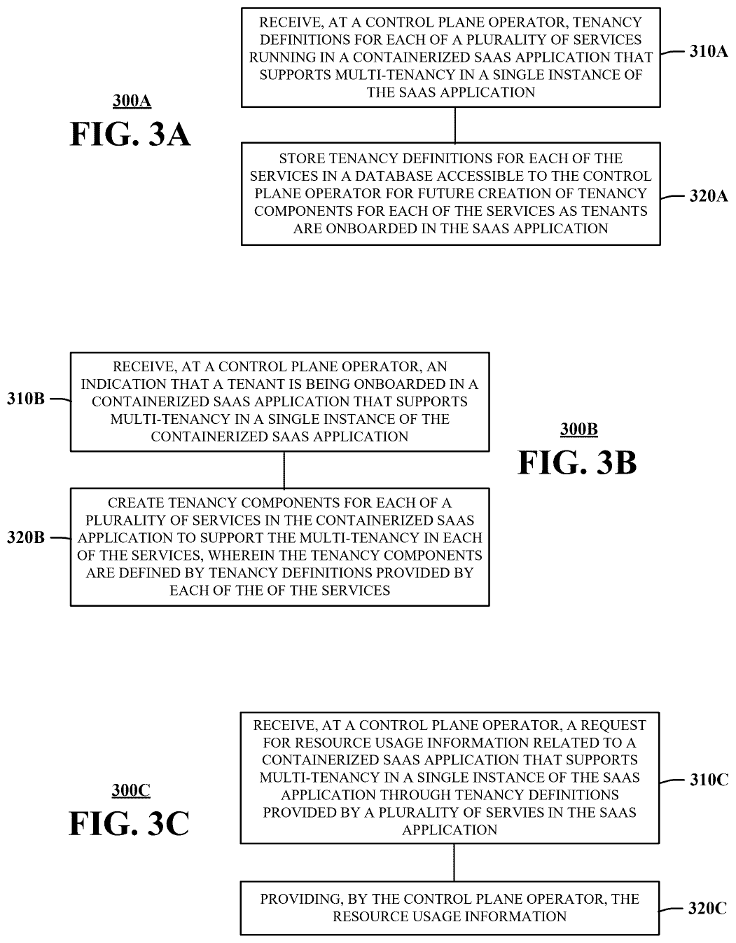

FIGS. 3A-3C depict illustrative embodiments of methods in accordance with various aspects described herein. Method 300A in FIG. 3A represents actions taken when a multi-tenancy containerized SaaS application is deployed, and the SaaS application has multiple services that can define their own multi-tenancy requirements through tenant definitions in Service CRDs.

At 310A, a control plane operator receives tenancy definitions for each of a plurality of services running in a containerized SAS application that supports multi-tenancy in a single instance of the SaaS application. Referring back to FIG. 1, in some embodiments, this corresponds to tenancy control plane operator 110 receiving tenancy definitions in Service CRDs created by services within SaaS application 150 when they are deployed. In some embodiments, the tenant control plane operator may be alerted that a Service CRD has been created. For example, the tenant control plane operator may set up a watch event, such that the tenant control plane operator is alerted whenever a Service CRD is created. Once the tenant control plane operator is alerted that a service CRD has been created, the control plane operator may retrieve the contents of the service CRD using the Kubernetes API.

At 320A, the tenancy definitions for each of the services are stored in a database accessible to the control plane operator for future creation of tenancy components for each of the services as tenants are onboarded in the SAS application. Referring back to FIG. 1, in some embodiments, this corresponds to storing the tenancy definitions in database 112, which is accessible to tenancy control plane operator 110. In some embodiments, the tenancy definitions stored in database 112 are used in the onboarding process when communicating with each of the services. Examples of these communications are described above with reference to FIG. 2C.

Method 300B in FIG. 3B represents actions taken when a tenant is onboarded in a containerized SaaS application that supports multi-tenancy in a single instance of the containerized SaaS application. At 310B, a control plane operator receives an indication that a tenant is being onboarded in a containerized SaaS application that supports multi-tenancy in a single instance of the containerized SaaS application. Referring back to FIG. 1, this may correspond to a tenant control plane operator 110 receiving an indication that SaaS application 150 has created a Tenant CRD 130 for a new tenant that is being onboarded. In some embodiments, tenant control plane operator 110 may be alerted of the new Tenant CRD through the use of a watch event 116.

At 320B, tenancy components are created for each of a plurality of services in the containerized SaaS application to support the multi-tenancy in each of the services, wherein the tenancy components are defined by tenant definitions provided by each of the services. In some embodiments, the actions of 320B correspond to the actions shown in FIG. 2C, in which an onboarding operator within the tenancy control plane operator alerts each of the services that has created a Service CRD with a tenant definition that a new customer is being onboarded.

Method 300C in FIG. 3C represents actions taken when a request for resource usage is received at a control plane operator. At 310C, a control plane operator receives a request for resource usage information related to a containerized SaaS application that supports multi-tenancy in a single instance of the SaaS application through tenancy definitions provided by a plurality of services in the SaaS application. Referring now back to FIG. 1, this corresponds to receiving, at API 160, a request for resource usage by a tenant. At 320C, the control plane operator provides the resource usage information requested at 310C.

While for purposes of simplicity of explanation, the respective processes are shown and described as a series of blocks in FIGS. 3A-3C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

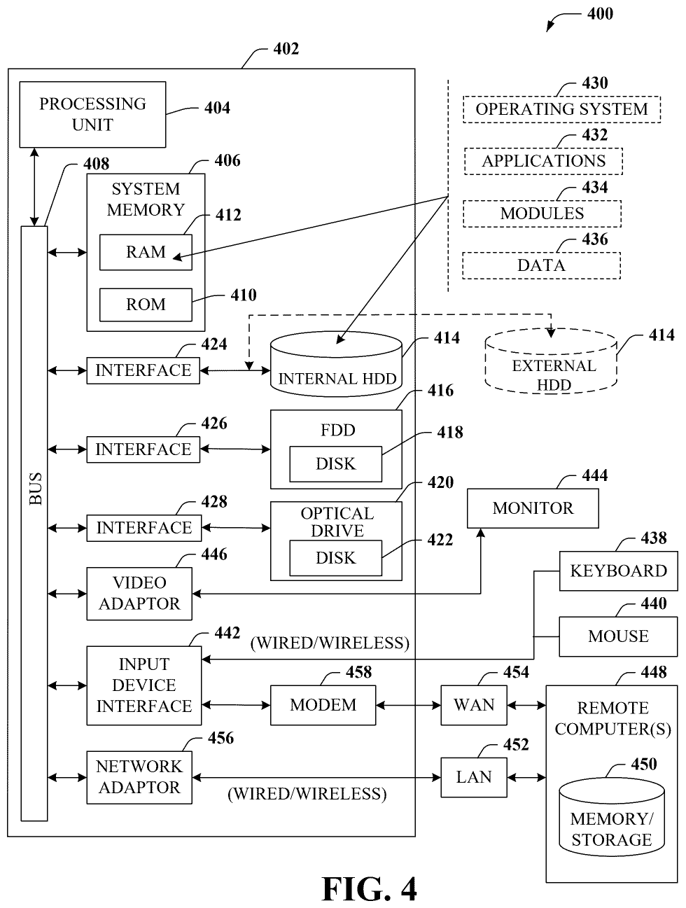

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. For example, computing environment 400 can facilitate in whole or in part the deployment of a containerized multi-tenancy SaaS application in a container orchestration platform. Multiple services may be included in the SaaS application, and the multiple services, upon deployment, may create Service CRDs with tenant definitions. A control plane operator may be alerted that service CRDs have been created, and may fetch and store them in persistent storage accessible to the tenant control plane operator. The SaaS application may onboard a tenant, and create a Tenant CRD for the new tenant. The tenant control plane operator may be alerted of the new tenant being onboarded, and may alert each of the services that created a Service CRD with a tenant definition. The tenant control plane operator may mark the Tenant CRD as complete, and workflow for the onboarded tenant may begin.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

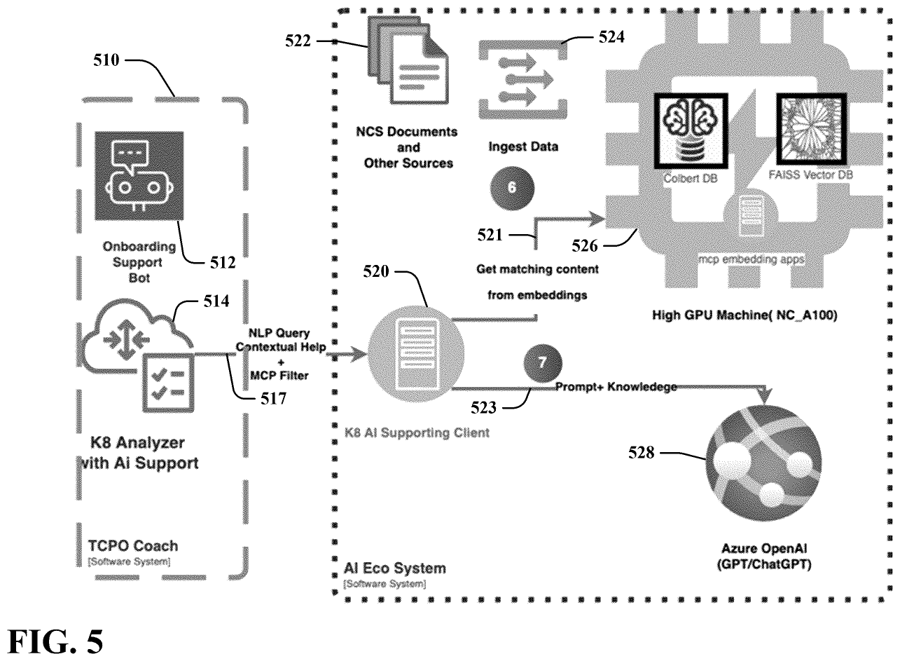

FIG. 5 is a block diagram illustrating an example, non-limiting embodiment of a system that includes a tenancy control plane operator coach that provides a natural language interface to a containerized orchestration platform in accordance with various aspects described herein.

FIG. 5 illustrates a block diagram of system components for a generative AI-based Tenancy Control Plane Operator (TCPO) Coach 510 in a Kubernetes environment. The figure depicts the integration of natural language processing, vector database technology, and live system orchestration to enable intuitive, context-aware tenancy management and resource analysis.

The TCPO Coach 510 is a software system configured to provide a natural language interface for users to interact with the tenancy control plane. In some embodiments, the TCPO Coach 510 includes an onboarding support bot 512 that is adapted to receive and process user queries in natural language. The TCPO Coach 510 may support multiple modes of interaction, including a chatbot interface and/or a command line interface. In some embodiments, the chatbot interface is configured to provide responses in layman's terms, making it accessible to users who may not have technical expertise in Kubernetes or multi-tenancy management. For example, a user may type, “Can I add a 6th tenant to my Kafka cluster?” and the chatbot interface may respond with, “The Kafka cluster is currently 80% utilized with 4 tenants. Adding a 6th tenant may require additional resources to avoid overloading the system.” In some embodiments, the command line interface is configured to provide technical responses for advanced users who are familiar with Kubernetes commands and resource management. For example, an advanced user may enter a query such as, “Show resource allocation for tenant profile ‘Gold’,” and the command line interface may return a detailed breakdown of resource usage, quotas, and isolation mechanisms for that tenant profile. The TCPO Coach 510 is adapted to interpret both conversational and technical queries, enabling a wide range of users to efficiently access and manage tenancy-related information within the container orchestration platform.

The Analyzer with AI Support 514 is configured to process and refine user queries, ensuring that the information retrieved is both accurate and contextually relevant. In some embodiments, the Analyzer with AI Support 514 is adapted to interpret the intent behind a user's natural language query and to correlate the query with relevant tenancy definitions, operational workflows, and system documentation. The Analyzer with AI Support 514 may interact with the NLP query contextual help and MCP filter 517, which is configured to provide contextual assistance and to filter queries based on management and control plane (MCP) policies or requirements. For example, if a user submits a query such as, “Which tenant is about to cross the resource usage threshold?” the Analyzer with AI Support 514 may leverage the contextual help and MCP filter 517 to identify the appropriate resource thresholds and to ensure that the response is aligned with current MCP policies. In another example, if an operator asks, “Which service is oversubscribed by any tenant?” the Analyzer with AI Support 514 may refine the query to focus on services with resource usage exceeding predefined limits and may filter the results to comply with access control or policy constraints. By combining advanced natural language processing with policy-aware filtering, the Analyzer with AI Support 514 is adapted to deliver responses that are tailored to the user's context and the operational environment of the container orchestration platform.

NCS Documents and Other Sources 522 represent static information sources that provide foundational knowledge for tenancy management within the container orchestration platform. These sources may include system documentation, custom resource definitions (CRDs) for each service, onboarding workflows, operational policies, and other technical references relevant to the deployment and management of multi-tenant SaaS applications. For example, NCS Documents and Other Sources 522 may contain YAML files describing tenancy definitions for services such as Kafka or Postgres, onboarding checklists for different tenant profiles, and documentation outlining resource allocation strategies or quota enforcement mechanisms. By aggregating these diverse sources, the system ensures that both domain-specific and general operational knowledge are available for query processing and analysis.

The Ingest Data module 524 is adapted to process the static information from NCS Documents and Other Sources 522 and convert it into embeddings suitable for storage and similarity search within the vector database 526. In some embodiments, the Ingest Data module 524 utilizes natural language processing models to transform textual and structured data into high-dimensional vector representations that capture the semantic meaning of the original content. For example, when a new CRD defining a tenancy policy is added or when onboarding documentation is updated, the Ingest Data module 524 generates corresponding embeddings and updates the vector database 526 in real time. This enables the system to efficiently retrieve the most relevant information in response to user queries, even as tenancy definitions and operational requirements evolve. The dynamic ingestion capability of the Ingest Data module 524 supports continuous adaptation to changes in service configurations and organizational policies.

The vector database 526 is configured to store embeddings generated from static information sources, such as tenancy definitions, system documentation, and operational workflows. In some embodiments, the vector database 526 may include multiple embedding databases, such as ColBERT DB and FAISS Vector DB, each adapted to support high-performance similarity search and retrieval. The embeddings represent the semantic content of the original information as high-dimensional vectors, allowing the system to compare and match user queries with relevant content even when the queries are phrased differently from the source material.

The Get Matching Content from Embeddings module 521 is configured to perform similarity search operations within the vector database 526. In some embodiments, similarity measures such as cosine similarity are used to compare the embedding of a user query with the embeddings stored in the database. For example, if a user submits a query such as, “What are the onboarding requirements for a Gold profile tenant?” the module 521 computes the embedding for the query and searches for the most similar embeddings in the vector database 526. The system then retrieves the content—such as onboarding checklists, resource allocation rules, or quota specifications—that most closely matches the user's intent. This approach enables efficient and accurate identification of relevant information, supporting both technical and non-technical queries across a wide range of tenancy management scenarios.

The AI Eco System, including the large language model (LLM) module 528, is configured to process prompts and knowledge provided by the K8 AI Supporting Client 520. The large language model 528 is adapted to interpret combined static and live data, generate Kubernetes commands as needed, and produce contextually relevant natural language responses. For example, when a user submits a query such as, “Can I onboard a new tenant with a medium-sized profile?” the large language model 528 receives a prompt containing relevant onboarding requirements and current resource availability, and generates a response that explains whether onboarding is feasible and what actions may be required. In another example, if a user requests, “Show resource usage for tenant profile ‘Gold’,” the large language model 528 may generate and execute Kubernetes commands to obtain live data, combine this data with static tenancy definitions, and return a detailed, user-friendly summary of resource consumption and any potential constraints. The large language model 528 is further configured to provide actionable recommendations, troubleshooting guidance, or technical breakdowns depending on the user's query and the operational context.

The AI Supporting Client 520 acts as an orchestrating agent, managing the flow of information between the TCPO Coach 510, the analyzers, and the AI ecosystem. The K8 AI Supporting Client 520 is configured to receive processed queries and to coordinate the retrieval of relevant information from the vector database 526 and LLM 528. In some embodiments, the K8 AI Supporting Client 520 receives a query that has been refined and contextualized by the analyzers and then initiates a similarity search within the vector database 526 to identify the most relevant static information, such as tenancy definitions, onboarding workflows, or operational documentation. The K8 AI Supporting Client 520 may interact with vector database 526 as shown at Get Matching Content from Embeddings 521 to perform this search, leveraging embeddings generated from the ingested static information. For example, if a user requests, “Show the onboarding requirements for a Gold profile tenant,” the K8 AI Supporting Client 520 may retrieve the corresponding onboarding documentation and tenancy criteria from the vector database 526. In another example, if a user asks, “What are the resource limits for Kafka tenants?” the K8 AI Supporting Client 520 may identify and retrieve the relevant resource allocation rules and quota specifications. In some embodiments, the K8 AI Supporting Client 520 is further adapted to combine the retrieved static information with prompt engineering techniques, as shown at Prompt+Knowledge 523, to generate context-rich prompts for the AI ecosystem. This enables the system to provide responses that are both technically accurate and tailored to the user's specific query and operational context.

Interactions between the components shown in FIG. 5 may begin when a user submits a query through the TCPO Coach 510, either using the chatbot interface or the command line interface. The query is first received by the K8 Analyzer with AI Support 512, which interprets the user's intent and correlates the query with relevant tenancy definitions, operational workflows, and system documentation. The Analyzer with AI Support 514 further refines the query, ensuring that the information retrieved is both accurate and contextually relevant. During this process, the NLP query contextual help and MCP filter 517 may provide additional contextual assistance and apply management and control plane (MCP) policy filters to the query, ensuring that the response aligns with organizational requirements and access controls.

Once the query has been processed and refined, it is forwarded to the K8 AI Supporting Client 520. The K8 AI Supporting Client 520 acts as an orchestrator, initiating a similarity search within the vector database 526 by leveraging the Get Matching Content from Embeddings module 521. The vector database 526, which stores embeddings generated from static information sources such as NCS Documents and Other Sources 522, enables efficient retrieval of the most relevant content. The Ingest Data module 524 ensures that the vector database 526 remains up to date by continuously converting new or modified static information into embeddings.

After retrieving the relevant static information, the K8 AI Supporting Client 520 combines this information with prompt engineering techniques using the Prompt+Knowledge module 523. This process generates a context-rich prompt that is submitted to the LLM 528. In some embodiments, the LLM 528 processes the prompt and, upon determining that live data is required to answer the query, provides a response to the K8 AI Supporting Client 520 indicating the need for specific live data. The K8 AI Supporting Client 520 then forms and executes one or more API calls to the container orchestration platform to retrieve the requested live data. Once the live data is obtained, the K8 AI Supporting Client 520 supplies this data to the LLM 528. The large language model then synthesizes the static information and the newly acquired live data to produce a contextually relevant natural language response.

The resulting response is returned to the user via the TCPO Coach 510. For example, if a user asks, “Can I add a 6th tenant to my Kafka cluster?” the system retrieves the relevant tenancy definitions and current resource usage, executes any required live queries, and provides a clear, actionable answer such as, “The Kafka cluster is currently 80% utilized with 4 tenants. Adding a 6th tenant may require additional resources to avoid overloading the system.” This workflow enables both technical and non-technical users to efficiently access and manage tenancy-related information within the container orchestration platform.

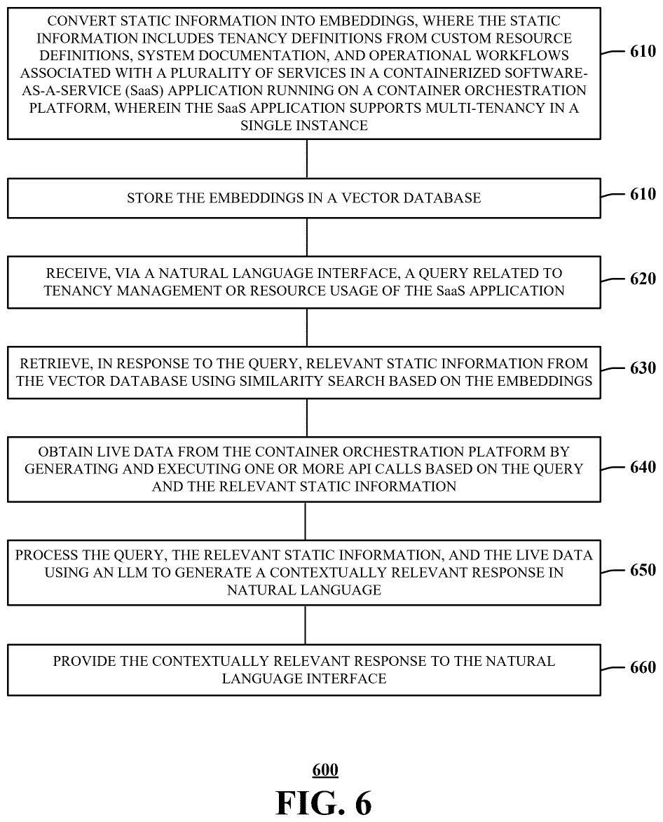

FIG. 6 depicts illustrative embodiments of methods in accordance with various aspects described herein. FIG. 6 depicts an illustrative embodiment of a method for generative AI-based tenancy management and resource analysis in a containerized Software-as-a-Service (SaaS) application running on a container orchestration platform. The method 600, as shown in FIG. 6, may be performed by a processing system including a processor executing instructions stored on a non-transitory machine-readable medium. The steps illustrated in FIG. 6 provide explicit support for claim 1, as well as the other independent and dependent claims, by encompassing the technical concepts described in the invention disclosure and the conversation with the inventors.

At block 610, the method involves converting static information into embeddings, where the static information includes tenancy definitions from custom resource definitions (CRDs), system documentation, and operational workflows associated with a plurality of services in a containerized SaaS application running on a container orchestration platform. In some embodiments, the static information may be sourced from NCS Documents and Other Sources, including YAML files, onboarding checklists, resource allocation strategies, and quota enforcement mechanisms. The Ingest Data module is configured to process this static information and generate high-dimensional vector representations, or embeddings, that capture the semantic meaning of the original content. This conversion enables efficient similarity search and retrieval in subsequent steps.

The embeddings generated from the static information are then stored in a vector database, as shown in block 610. The vector database may include multiple embedding databases, such as ColBERT DB and FAISS Vector DB, each adapted to support high-performance similarity search and retrieval. The vector database is dynamically updated as new or modified tenancy definitions, documentation, or operational workflows are ingested at runtime, supporting continuous adaptation to changes in service configurations and organizational policies.

In some embodiments, the system may also be adapted to update the vector database with new or modified onboarding requirements and operational workflows as they become available. For example, when a service introduces a new tenant profile or modifies the steps required for onboarding, the updated documentation or workflow definitions are ingested by the Ingest Data module. The module processes the new information, generates updated embeddings, and stores them in the vector database. This enables the system to provide users with the most current onboarding procedures and requirements in response to natural language queries. In another example, if an organization changes its operational policies for resource allocation or quota enforcement, the revised policies are incorporated into the vector database, ensuring that all subsequent queries and recommendations reflect the latest operational standards. This continuous updating capability supports agile adaptation to evolving business needs and technical requirements.

At block 620, the method includes receiving, via a natural language interface, a query related to tenancy management or resource usage of the SaaS application. The natural language interface may comprise a chatbot interface configured to provide responses in layman's terms for non-technical users, as well as a command line interface configured to provide technical responses for advanced users. For example, a user may ask, “Can I add a 6th tenant to my Kafka cluster?” or “Show resource allocation for tenant profile ‘Gold’.” The TCPO Coach is adapted to interpret both conversational and technical queries, enabling a wide range of users to efficiently access and manage tenancy-related information.

In some embodiments, the natural language interface is configured to tailor responses based on the user's expertise and the mode of interaction. For example, the chatbot interface may provide simplified, layman's explanations for non-technical users, while the command line interface may deliver detailed technical breakdowns, including specific Kubernetes commands, resource quotas, and isolation mechanisms. This dual-mode support ensures accessibility and usability for a broad range of users.

At block 630, in response to the query, the method retrieves relevant static information from the vector database using similarity search based on the embeddings. The Get Matching Content from Embeddings module is configured to perform similarity search operations, such as cosine similarity, to compare the embedding of the user query with the embeddings stored in the database. This enables the system to identify and retrieve the most relevant content, such as onboarding requirements, resource allocation rules, or quota specifications, even when the user's query is phrased differently from the source material.

In some embodiments, the vector database utilizes similarity measures, such as cosine similarity, to match user queries with relevant content stored as embeddings. When a query is received, the system computes the embedding for the query and compares it to the stored embeddings, retrieving the most semantically similar content. This approach enables efficient and accurate identification of relevant information, even when the user's query is phrased differently from the source material.

At block 640, the method obtains live data from the container orchestration platform by generating and executing one or more application programming interface (API) calls based on the query and the relevant static information. In some embodiments, the large language model (LLM) processes the prompt and, upon determining that live data is required, provides a response to the orchestrating agent (such as the K8 AI Supporting Client) indicating the need for specific live data. The orchestrating agent then forms and executes the necessary API calls to the container orchestration platform, retrieves the requested live data, and supplies it to the LLM. This step enables the system to combine real-time operational data with static tenancy definitions and documentation.

At block 650, the method processes the query, the relevant static information, and the live data using a large language model to generate a contextually relevant response in natural language. The large language model is configured to interpret combined static and live data, generate Kubernetes commands as needed, and produce actionable recommendations, troubleshooting guidance, or technical breakdowns depending on the user's query and the operational context. For example, the large language model may assess the feasibility of onboarding a new tenant with a specified profile based on current resource availability and predefined tenancy criteria, or provide a detailed summary of resource consumption and any potential constraints.

In some embodiments, the large language model is further configured to generate Kubernetes commands based on the user's query and the retrieved static information. For example, if live data is required, the model may produce commands to query resource availability or usage statistics. Additionally, the model may provide actionable recommendations, such as scaling resources or redistributing tenants, based on the combined analysis of static and live data.

In some embodiments, in response to user queries, the large language model may generate detailed, step-by-step onboarding workflows tailored to the specific requirements of each tenant profile and service. Additionally, the system may provide summaries of resource usage trends for individual tenants or profiles, as well as explanations of any resource constraints or policy limitations that may impact onboarding or ongoing operations. These features enhance transparency and support informed decision-making for both technical and non-technical users.

At block 660, the method provides the contextually relevant response to the natural language interface, delivering the generated response to the user. The response may include an assessment of onboarding feasibility, resource usage trends, recommendations for resource scaling or tenant redistribution, explanations of resource constraints, or step-by-step onboarding workflows. The system is further configured to log each user query and the corresponding response for audit or compliance purposes.

In some embodiments, the system is further configured to log each user query and the corresponding response generated by the large language model. These logs may be used for audit, compliance, or troubleshooting purposes, providing a record of user interactions and system recommendations. In some embodiments, the logs may include timestamps, user identifiers, and the context of each query, supporting robust operational oversight.

While for purposes of simplicity of explanation, the respective processes are shown and described as a series of blocks in FIG. 6, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A non-transitory machine-readable medium, comprising executable instructions that, when executed by a processing system including a processor, facilitate performance of operations, the operations comprising:
converting, into embeddings, static information comprising tenancy definitions from custom resource definitions, system documentation, and operational workflows associated with a plurality of services in a containerized Software-as-a-Service (SaaS) application running on a container orchestration platform, wherein the SaaS application supports multi-tenancy in a single instance;
storing the embeddings in a vector database;
receiving, via a natural language interface, a query related to tenancy management or resource usage of the SaaS application;
retrieving, in response to the query, relevant static information from the vector database using a similarity search based on the embeddings;
obtaining live data from the container orchestration platform by generating and executing one or more application programming interface (API) calls based on the query and the relevant static information;
processing the query, the relevant static information, and the live data using a large language model to generate a contextually relevant response in natural language; and
providing the contextually relevant response to the natural language interface.

2. The non-transitory machine-readable medium of claim 1, wherein the natural language interface comprises a chatbot interface configured to provide responses in layman's terms for non-technical users.

3. The non-transitory machine-readable medium of claim 1, wherein the natural language interface comprises a command line interface configured to provide technical responses for advanced users.

4. The non-transitory machine-readable medium of claim 1, wherein the vector database utilizes cosine similarity to match the query with relevant content.

5. The non-transitory machine-readable medium of claim 1, wherein the operations further comprise dynamically ingesting updated tenancy definitions or documentation into the vector database at runtime in response to changes in service tenancy requirements.

6. The non-transitory machine-readable medium of claim 1, wherein the obtaining the live data comprises generating Kubernetes commands to obtain live resource availability data from the container orchestration platform.

7. The non-transitory machine-readable medium of claim 1, wherein the operations further comprise updating the vector database with new or modified static information in response to changes in service tenancy definitions or operational workflows at runtime.

8. The non-transitory machine-readable medium of claim 1, wherein the large language model is configured to generate Kubernetes commands based on the query and the relevant static information to obtain the live data from the container orchestration platform.

9. The non-transitory machine-readable medium of claim 1, wherein the contextually relevant response generated by the large language model includes actionable recommendations for resource scaling or tenant redistribution based on the relevant static information and the live data.

10. The non-transitory machine-readable medium of claim 1, wherein the operations further comprise updating the vector database with new or modified onboarding requirements in response to changes in service tenancy definitions.

11. A non-transitory machine-readable medium, comprising executable instructions that, when executed by a processing system including a processor, facilitate performance of operations, the operations comprising:
receiving, via a natural language interface, a query related to tenancy management of a containerized Software-as-a-Service (SaaS) application running on a container orchestration platform, wherein the containerized SaaS application supports multi-tenancy in a single instance and comprises a plurality of services, each service providing tenancy definitions via custom resource definitions;
retrieving, in response to the query, static tenancy information from a vector database, the vector database comprising embeddings of tenancy definitions, documentation, and operational workflows associated with the plurality of services;
processing the query and the static tenancy information using a large language model to generate a contextually relevant response in natural language; and
providing the contextually relevant response to a user via the natural language interface.

12. The non-transitory machine-readable medium of claim 11, wherein the operations further comprise obtaining live data from the container orchestration platform by generating and executing one or more application programming interface (API) calls based on the query and the static tenancy information.

13. The non-transitory machine-readable medium of claim 11, wherein the containerized SaaS application is deployed in a common Kubernetes namespace.

14. The non-transitory machine-readable medium of claim 11, wherein the natural language interface comprises a chatbot interface configured to provide responses in layman's terms for non-technical users.

15. The non-transitory machine-readable medium of claim 11, wherein the natural language interface comprises a command line interface configured to provide technical responses for advanced users.

16. The non-transitory machine-readable medium of claim 11, wherein the vector database utilizes cosine similarity to match the query with relevant content.

17. The non-transitory machine-readable medium of claim 11, wherein the operations further comprise dynamically ingesting updated tenancy definitions or documentation into the vector database at runtime in response to changes in service tenancy requirements.

18. The non-transitory machine-readable medium of claim 11, wherein the contextually relevant response includes an assessment of a feasibility of onboarding a new tenant with a specified profile based on current resource availability and predefined tenancy criteria.

19. A non-transitory machine-readable medium, comprising executable instructions that, when executed by a processing system including a processor, facilitate performance of operations, the operations comprising:
receiving, via a natural language interface, a request for resource usage information related to a containerized Software-as-a-Service (SaaS) application running on a container orchestration platform, wherein the containerized SaaS application supports multi-tenancy in a single instance;
obtaining live resource usage data from the container orchestration platform by generating and executing one or more application programming interface (API) calls based on the request;
processing the request and the live resource usage data using a large language model to generate a contextually relevant response in natural language; and
providing the contextually relevant response to a user via the natural language interface.

20. The non-transitory machine-readable medium of claim 19, wherein the containerized SaaS application is deployed in a common Kubernetes namespace.
